(19) United States
(12) Patent Application Publication
(10) Pub. No.: US 2017/0350972 A1
(43) Pub. Date: Dec. 7, 2017

(54) METHOD FOR OPERATING A COUNTER DEVICE FOR A FLUID, COUNTER DEVICE AND COUNTER SYSTEM

(71) Applicant: DIEHL METERING SYSTEMS GMBH, NUERNBERG (DE)

(72) Inventors: ROLAND GOTTSCHALK, WENDELSTEIN (DE); MARKUS SCHMIDT, WICKLESGREUTH (DE); KLAUS GOTTSCHALK, WINKELHAID (DE)

(21) Appl. No.: 15/613,631

(22) Filed: Jun. 5, 2017

(30) Foreign Application Priority Data
Jun. 3, 2016 (DE) 10 2016 006 812.4

(51) Int. Cl. G01S 13/74; G08C 17/02; G01F 3/00

(52) U.S. Cl. CPC G01S 13/74; G08C 17/02; G01F 3/00

(57) ABSTRACT

A method operates a counter device for a fluid which can be connected via a connecting device to a meter point having at least one line through which the fluid flows. A control device is configured when connected via at least one operating parameter specific for the meter point and/or a meter point environment. When the counter device is taken into operation, the operating parameters are called up by a communication device on the counter device side communicating wirelessly by radio via a communication link with a passive communication device on the meter point side. The operating parameters are stored in a storage device of the passive communication device.

### CROSS-REFERENCE TO RELATED APPLICATION

This application claims the priority, under 35 U.S.C. §119, of German application DE 10 2016 006 812.4, filed Jun. 3, 2016; the prior application is herewith incorporated by reference in its entirety.

### BACKGROUND OF THE INVENTION

### FIELD OF THE INVENTION

The invention relates to a method for operating a counter device for a fluid which can be connected via a connecting device to a meter point having at least one line through which the fluid flows, and has a control device which, when connected via at least one operating parameter specific for the meter point and/or a meter point environment, is configured, a counter device for a fluid and a counter system for a fluid.

Counter devices for fluids, frequently also called “counter” in brief, are already widely known in the prior art and are used for determining consumption data of the fluid, for example in the domestic area for heater heat, for hot water and for cold water. Such counter devices have usually at least one arithmetic unit in a housing which is connected to a transmitter, particularly a volume transmitter, and possibly other sensors which, if necessary, can also be provided externally as part of the meter point. For example, heat counters are known as counter devices in which an arithmetic unit is connected to one volume transmitter and two temperature sensors, the heat counting being carried out by continuous detection of the volume which has flowed through and the temperature difference between the flow temperature and the runback temperature. For simple counter devices which are only intended to measure the consumption of the fluid itself, a volume transmitter is frequently already sufficient. In this context, a multiplicity of different types of volume transmitters are known in the prior art, for example mechanical volume transmitters (for example impeller wheel meters), magnetically inductively operating volume transmitters and ultrasonic volume transmitters. These deliver, for example, measuring pulses to an arithmetic unit which has to interpret these.

The arithmetic unit, in turn, forms part of a control device for the counter device to which various operating parameters must be known in order to be configured correctly for the current meter point. If, for example, the counter device also has a transmitting device with which consumption data which had been determined by the arithmetic unit are to be transmitted wirelessly to a data collection device for consumption data, it must be known, on the one hand, how the communication link to the data collection device can be established, but on the other hand, an identification information item of the meter point must be allocated to the consumption data for a correct allocation at least when a number of counter devices send their consumption data to the data collection device. Another example of an operating parameter is a starting count which is to be utilized when the counter device in the meter point starts its operation.

In order to provide for the configuration of a counter device at a meter point having at least one fluid line through which the fluid is conducted, various approaches are already known. On the one hand, it is possible to provide the counter device itself with an input means or to connect the counter device to an input means such that the operating parameters needed can be conveyed manually to the control device or else the fitting configuration can be carried out directly. Conveying operating parameters to the counter device can also take place with the aid of an optical diode and a suitable remote station, the configuration or parameterization having to be carried out, in turn, by a service person. It should be noted that such counter devices having their own intelligence via a control device are frequently also called “smart meters”.

### SUMMARY OF THE INVENTION

The invention is thus based on the object of providing for a simplification of the configuration and/or parameterization of a counter device after its installation at the meter point.

To achieve this object, it is provided in a method of the type initially mentioned, according to the invention, that at least when the counter device is taken into operation, the operating parameters are called up by means of a communication device on the counter device side by a passive communication device on the meter point side, in the storage device of which the operating parameters are stored, wirelessly by radio via a communication link and are used for configuration of the control device.

The concept forming the basis of the invention is thus to call up via an ideally short-range communication link the operating parameters needed for the configuration automatically on start-up of the counter device from a passive communication device which has a storage device in which the operating parameters are stored and also fully automatically use them by the control device for configuration of the counter device, that is to say of the smart meter. The communication device on the side of the meter point is passive, which means it does not become independently active to transmit but only following an activation request, particularly, therefore, following a request signal of the communication device on the counter device side. Thus, no energy supply or continuously active energy source is needed from the passive communication device on the meter point side. The configuration process is carried out automatically by the control device, which means that the control device controls the communication device on the meter point side for requesting the operating parameters and then configures itself or its components, respectively, particularly an arithmetic unit, automatically accordingly. Since the communication device on the meter point side is passive, it can be considered to be a type of “radiolabelling”.

The present invention thus achieves the advantage that no configuration and/or parameterization effort by a service person is needed for the counter device. The counter device only needs to be installed at the meter point and taken into operation so that the correct configuration to the meter point occurs fully automatically. Starting up the counter device can be mapped internally in the control device via a trigger signal, wherein it can be provided that, particularly up to the first configuration produced automatically, an enquiry signal is sent out to communication devices on the meter point side cyclically after a configuration signal or start up signal triggering the configuration. In this context, it should be pointed out that a configuration signal naturally can be generated also by user interaction, for example via a suitable internal or external input means in order to trigger a reconfiguration in a manner initiated by a user which, however, again occurs completely automatically after the passive communication device on the meter point side is within communication range of the counter device or its communication device on a meter point side. If this is not the case, therefore, should there be no response from a passive communication device on the meter point side, for example following the cyclic enquiry signal after a number of repetitions exceeding a threshold value, an error signal can be output.

With particular advantage, an RFID transponder and/or a near field communication device (NFC device) can be used as communication device on the meter point side. In particular, RFID transponders are already known in other fields of application in the prior art. They comprise mostly an antenna and a microchip with storage device, the antenna being utilized for receiving enquiry signals which, at the same time, deliver the energy needed for conveying the operating parameters which are deposited in the storage device of the RFID transponder. Correspondingly, an RFID reader is needed as communication device on the side of the counter device. However, other types of near field communication (NFC) can also be used within the context of the present invention, for example, NFC devices or interfaces as are currently known from mobile telephones. If the communication device on the meter point side is designed as such an NFC device, a corresponding NFC interface must be provided as communication device on the counter device side.

In this context, it is incidentally also appropriate if the communication range of the communication link between the communication devices is less than 20 cm, particularly less than 10 cm. In this way, it is possible to ensure that even with adjacent meter points, only the passive communication device on the meter point side is read out, which is also allocated to the meter point in which the counter device has been installed.

It is also appropriate if the communication device on the meter point side is integrated in a nameplate of the meter point. In this way, an optical identification readable by an operator or a service person, of the meter point is combined with a “radio labelling” which can be read out electronically and wirelessly by the counter device wherein, for example, an RFID transponder can be integrated in a plastic sign and/or a printed RFID label can be used. This electronic and possibly also optical “labelling” is described at the latest with the first use of the meter point by the supplier with the needed initial values for the operating parameters.

It can also be provided that the communication link uses magnetic alternating fields and/or a frequency in the range from 13 to 14 MHz. In particular, it can be provided that the communication by means of alternating magnetic field is used at a frequency of 13.56 MHz which is found to be appropriate in the use of RFID technology and NFC technology in each case.

Preferably, an identification information item of the meter point and/or a starting count and/or communication data for establishing a communication link with a data collection device for consumption data of the counter device can be used as operating parameters. In particular, a transmitting device is thus provided by the counter device, particularly as part of the control device, via which particular consumption data can be transmitted wirelessly to a data collection device, particularly by radio, by means of the arithmetic unit which is also part of the control device. In this context, an identification information item must also be allocated to the consumption data at least when the data collection device receives consumption data of a number of counter devices. In such a configuration, the identification information and the communication data must be kept available correspondingly for establishing the transmitting link with the data collection device and used correspondingly automatically for the configuration. Further useful information for configuring the counter device is a starting count from which the consumption data are to be counted.

The communication device on the meter point side can be mounted at the meter point during installation of the meter point, wherein the operating parameters are or will be stored. This means as soon as the meter point for the fluid is provided in order to accommodate a counter device, the electronic “labelling” is also attached at the same time and can already contain the operating parameters in its storage device, or else the operating parameters are then fed correspondingly into the storage device.

In a preferred development of the method according to the invention, it is provided that the counter device, particularly during establishment of the communication link, transmits the energy needed for operation of the communication device on the meter point side to the communication device on the meter point side. In the known RFID embodiments, for example, it is frequently already such that the RFID transponders do not have their own energy source or do not need an energy supply link but store the energy contained in the enquiry signal or other signal addressing the RFID transponders at least for a short time and use it for operating the local control unit, particularly the microchip. Such concepts have already been proposed also for NFC facilities. Thus, it is also preferred according to the invention that the passive communication device on the meter point side needs neither its own energy source nor an energy supply line.

In a particularly preferred embodiment of the present invention, it can be provided that in the case of the presence of an updating signal in the counter device, altered, updated operating parameters are transmitted via the communication link to the communication device on the meter point side which stores the updated operating parameters in the storage device. This means that whenever the counter device changes the configuration/parameterization during its life or is exchanged and different values from the original values are to be used as initial values of the operating parameters for the following counter device, for example as related to the starting count, these new updated values of the operating parameters are written into the storage device of the communication device on the meter point side with the aid of the communication link. In this way, fully automatic configuration/parameterization can occur also when the counter device is exchanged. Particularly, it can be provided that in the case of an exchange of the counter device an update of the operating parameters occurs in the communication device on the meter point side by the old counter device, particularly initiated by a user, and, after installation of the new counter device, the latter, after the updated operating parameters have been called up, is configured by means of these. An updating signal by means of which updated operating parameters are conveyed to the communication device on the meter point side can then be produced automatically, for example during a “shutdown” of the counter device and/or also be initiated by the user wherein an automatic creation of an updating signal can also be provided with an updating of the configuration which includes a change in the values of the operating parameters. Thus, a completely or at least almost completely automatic configuration of a new counter device or reconfiguration of the same counter device is possible after a restart.

Apart from the method, the invention also relates to a counter device having a communication device on the meter point side for wireless communication by radio with a passive communication device on the meter point side, and a control device which is configured for activating the communication device on the counter device side for calling up operating parameters for the communication device on the meter point side and for configuration of the counter device according to the operating parameters called up. All embodiments with respect to the method according to the invention can be transferred analogously to the counter device according to the invention by which the aforementioned advantages can be achieved similarly.

In this context, it should be noted again at this point that the communication device on the counter device side can also be implemented, on the one hand, as part of the control device; in particular, it can be provided even that the control device and the communication device on the counter device side are implemented to be integrated. Thus, for example, microcontrollers have been proposed into which a near field communication interface has already been integrated, for example, therefore, a near field communication device or an RFID reader. By this means, an extremely compact design of the counter device can be implemented.

Finally, the invention also relates to a counter system containing a counter device according to the invention and a communication device on the meter point side having a storage device for the operating parameters. The counter system is configured, in particular, for performing the method according to the invention. All statements with regard to the method according to the invention and to the counter device according to the invention apply analogously to the counter system according to the invention.

Other features which are considered as characteristic for the invention are set forth in the appended claims.

Although the invention is illustrated and described herein as embodied in a method for operating a counter device for a fluid, a counter device and a counter system, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration showing a basic diagram of a meter point with an installed counter device;

FIG. 2 is an illustration showing a counter system according to the invention; and

FIG. 3 is a flowchart of a method for configuring a counter device to a meter point.

### DETAILED DESCRIPTION OF THE INVENTION

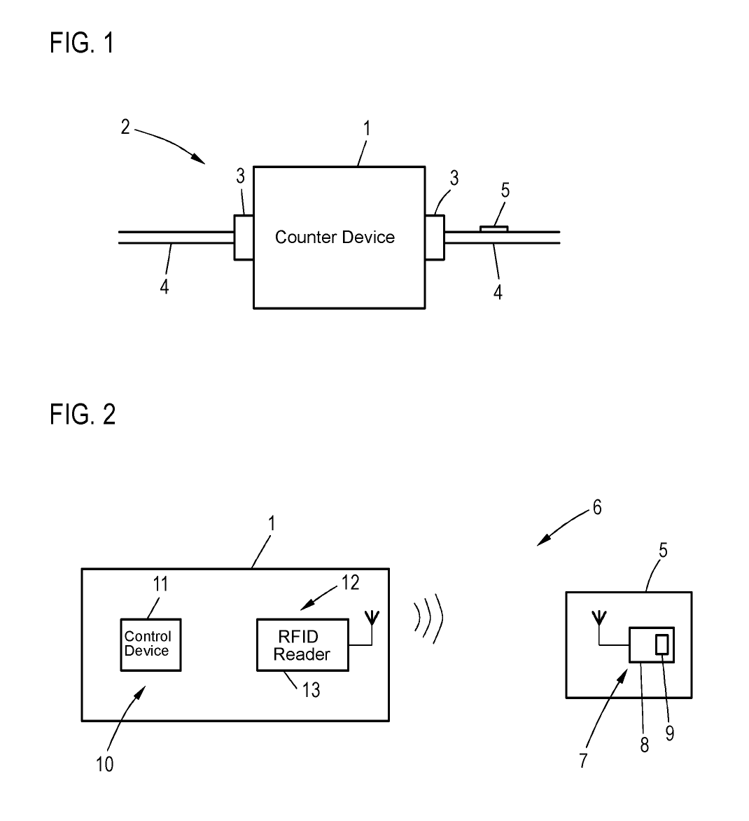

Referring now to the figures of the drawings in detail and first, particularly to FIG. 1 thereof, there is shown a basic diagram of a counter device 1 which has been installed at a meter point 2 by a corresponding mounting device 3. On the side of one of the fluid lines 4, a nameplate 5 is visibly provided which, apart from an optically readable description of the meter point 2, directed at the service personnel, also contains a communication device on the meter point side which communicates with a communication device on the counter device side when taken into operation for the completely automatic configuration of the counter device 1 installed.

The corresponding counter system 6 or communication system, respectively, is shown more accurately in FIG. 2. The nameplate 5 which, for example, can be configured as a plastic sign, visibly contains a passive communication device 7 on the meter point side which is configured as an RFID device 8 (RFID transponder). The communication device 7 contains a memory or storage device 9 in which operating parameters for configuration of the counter device 1 are stored. The operating parameters contain presently communication data for establishing a transmitter connection to a data collection device to which one transmitting device, not shown in greater detail here, of the counter device 1 is intended to convey consumption data wirelessly, an identification information item of the meter point 2 which is to be allocated to the consumption data to be transmitted to the data collection device, and a starting count.

The counter device 1 has as control device 10 presently a microcontroller 11 which is also configured as an arithmetic unit for evaluating sensor data of a transmitter, not shown in greater detail here, particularly a volume transmitter. Besides that, a communication device 12 on the counter device side is provided, in this case an RFID reader 13, which can also be designed to be integral with the microcontroller 11.

As mentioned, other components of the counter device 1 are not shown in greater detail for the sake of clarity. The control device 10 is then configured to activate the communication device 12 at least on taking the counter device 1 into operation for cyclically sending out an enquiry signal to communication devices 7 on the meter point side so that presently, the communication device 7 on the meter point side actually present, which receives its energy through the enquiry signal as known in principle in RFID systems in order to transmit the operating parameters from the storage device 9 to the communication device 12 on the counter device side. Received there, the operating parameters, in turn, are utilized fully automatically for providing for the configuration of the counter device 1 to the meter point 2 by the control device 10.

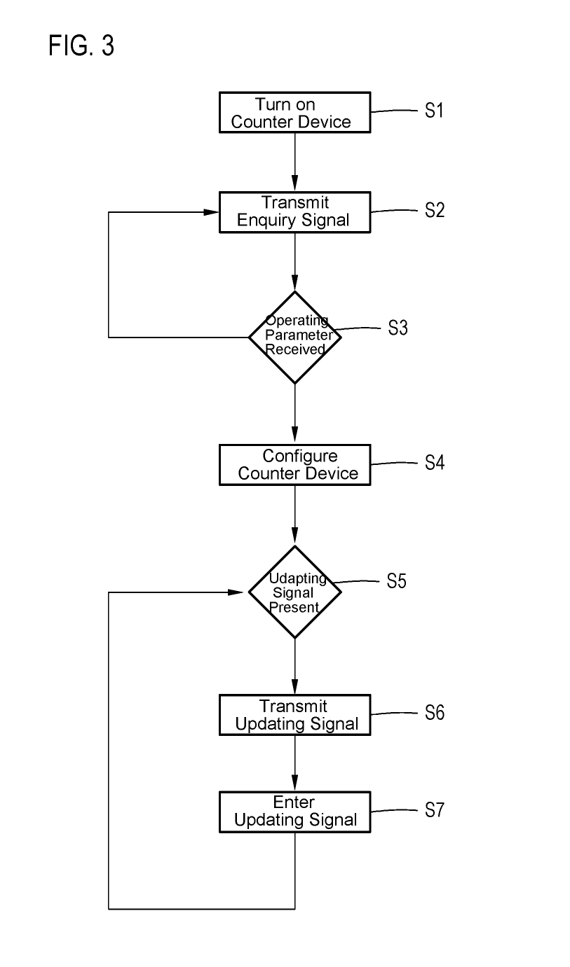

FIG. 3 shows a flowchart of an illustrative embodiment of the method according to the invention. In this context, the counter device 1 is taken into operation in a step S1 after installation of the counter device 1 at the meter point 2, by which means a configuration signal is produced which triggers the fully automatic configuration. Correspondingly, it is begun in a step S2 cyclically to send out an enquiry signal to the communication device 7 on the meter point side by means of the communication device 12 on the meter point side. In a step S3 it is checked whether operating parameters have been received in response. If this is not so, the cyclic sending out of the enquiry signal is continued, particularly until a predetermined number of attempts of contacting the communication device 7 has failed whereupon an error signal can be output which points to a necessary manual configuration.

If, however, operating parameters have been obtained in response in step S3, the completely automatic configuration of the counter device 1 occurs in a step S4 with utilization of the operating parameters by the control device 10.

In the further course, it is checked in step S5 whether an indicatory updating signal is present in the counter device 1 which indicates an impending exchange of the counter device 1 and/or a change of the configuration which is associated with updated operating parameters is present in the counter device 1. If this is so, the control device 10 activates the communication device 12 in a step S6 for sending out an updating signal which is received by the communication device 7 on the meter point side in a step S7. The energy transmitted is utilized for updating the values of the operating parameters similarly in the storage device 9 in step S7 in that the newly received values of the updating signal are entered.

In a reconfiguration of the counter device 1 now following or after installation of a new counter device 1 and taking it into operation, the updated operating parameters are then utilized in the storage device 9 for configuration.

Finally, it should also be noted that for communication between the communication devices 7 and 12 as known in principle in RFID systems, alternating magnetic fields are used at a frequency of 13.56 MHz. Furthermore, it should be pointed out that alternatively to the RFID technology described here, other NFC technologies can also be used in which the communication range, as provided here, is less than 20 cm, preferably less than 10 cm.

Furthermore, it should also be pointed out that the nameplate 5 can be attached already by a supplier during installation of the meter point 2 itself, the operating parameters already being stored or being stored then.

The following is a summary list of reference numerals and the corresponding structure used in the above description of the invention:
1 Counter device
2 Meter point
3 Mounting means
4 Fluid line
5 Nameplate
6 Counter system
7 Communication device on the meter point side
8 RFID device
9 Storage device
10 Control device
11 Microcontroller
12 Communication device on the counter device side
13 RFID reader
S1-S7 Step

1. A method for operating a counter device for a fluid which can be connected via a connecting device to a meter point having at least one line through which the fluid flows, which comprises the steps of:
providing the counter device with a control device, the control device being configured upon receiving at least one operating parameter specific for the meter point and/or a meter point environment;
putting the counter device into an operational mode by obtaining operating parameters by means of a communication device on a counter device side communicating wirelessly by radio via a communication link with a passive communication device on a meter point side, the passive communication device having a storage device in which the operating parameters are stored; and
using the operating parameters for configuring the control device.

2. The method according to claim 1, which further comprises:
providing the passive communication device on the meter point side as an radio frequency identification transponder and/or a near field communication device and a communication range of the communication link is less than 20 cm; and
integrating the passive communication device on the meter point side in a nameplate of the meter point.

3. The method according to claim 1, wherein the communication link uses at least one of alternating magnetic fields or a frequency in a range from 13 to 14 MHz.

4. The method according to claim 1, which further comprises selecting the operating parameters from the group consisting of identification information items of the meter point, a starting count, and communication data being used for establishing a communication link with a data collection device for consumption data of the counter device.

5. The method according to claim 1, wherein during installation of the meter point, mounting the passive communication device on the meter point side at the meter point, wherein the operating parameters are stored in the passive communication device.

6. The method according to claim 1, wherein the counter device, during establishment of the communication link, transmits energy needed for operation of the passive communication device on the meter point side wirelessly to the passive communication device on the meter point side.

7. The method according to claim 1, wherein in a case of a presence of an updating signal in the counter device, transmitting altered, updated operating parameters via the communication link to the passive communication device on the meter point side which stores the altered, updated operating parameters in the storage device.

8. The method according to claim 7, wherein in a case of an exchange of the counter device an update of the operating parameters occurs in the passive communication device on the meter point side by an old counter device, initiated by a user, and, after installation of a new counter device, the new counter device, after the altered, updated operating parameters have been called up, is configured by the altered, updated operating parameters.

9. The method according to claim 2, wherein the communication link is less than 10 cm.

10. The method according to claim 1, wherein the communication link uses at least one of alternating magnetic fields or a frequency of 13.56 MHz.

11. A counter device, comprising:
a communication device disposed on a counter device side for wireless communication by radio with a passive communication device on a meter point side; and
a control device configured for activating said communication device on the counter device side for calling up operating parameters from the passive communication device on the meter point side and for configuration of the counter device according to the operating parameters called up.

12. A counter system, comprising:
a passive communication device disposed on a meter point side and having a storage device for storing operating parameters; and
a counter device having a counter communications device disposed on a counter device side for wireless communication by radio with said passive communication device on the meter point side, said counter device having a control device configured for activating said counter communication device on the counter device side for calling up the operating parameters from said passive communication device on the meter point side for configuring said counter device according to the operating parameters called up.
